(19) United States
(12) Patent Application Publication
(10) Pub. No.: US 2013/0200820 A1
(43) Pub. Date: Aug. 8, 2013

(54) SCRIM LED LIGHTING APPARATUS

(71) Applicant: AMERICAN DJ SUPPLY, INC., Los Angeles, CA (US)

(72) Inventor: Toby Velazquez, Yorba Linda, CA (US)

(73) Assignee: AMERICAN DJ SUPPLY, INC., Los Angeles, CA (US)

(21) Appl. No.: 13/762,291

(22) Filed: Feb. 7, 2013

Related U.S. Application Data
(60) Provisional application No. 61/596,118, filed on Feb. 7, 2012.

(51) Int. Cl. H05B 33/08

(52) U.S. Cl. CPC H05B 33/0845
USPC 315/294

(57) ABSTRACT

Embodiments of the present invention provide a lighting apparatus comprising at least one scrim LED unit, an interface unit, and at least one portable remote control, wherein each portable remote control unit is configured to exchange information with the interface unit. Each scrim LED unit comprises a first scrim fabric and a plurality of LED lighting units. Each of the plurality of LED lighting units is attached to a reverse side of the first scrim fabric. Each scrim LED unit comprises a plurality of electrical cables capable of having multiple LED lighting units spaced thereupon. A main connector interconnects the interface unit to each of the plurality of electrical cables. Each LED lighting unit comprises an LED light and a mounting frame, wherein each LED light is detachably coupled to the mounting frame and each mounting frame affixes the LED lights onto the reverse side of the first scrim fabric.

### CROSS-REFERENCE TO RELATED APPLICATIONS

This application claims priority to U.S. Provisional Patent Application Ser. No. 61/596,118, filed on Feb. 7, 2012, which is incorporated herein by reference.

### BACKGROUND OF THE INVENTION

1. Field of the Invention

The present invention relates generally to lighting apparatuses, and in particular, to a lighting apparatus affixed to fabric.

2. Description of Related Art

Lighting apparatuses are used for illuminating both indoor and outdoor environments. Proper illumination is vital when filming movies, television shows, shooting videos, taking photographs, lighting live stage performances, and other similar activities.

### BRIEF SUMMARY OF THE INVENTION

Embodiments of the present invention provide a lighting apparatus comprising at least one scrim LED unit, an interface unit and at least one portable remote control. Each portable remote control unit is configured to exchange information with the interface unit. Each scrim LED unit comprises a first scrim fabric and a plurality of LED lighting units. The first scrim fabric comprises a display side and a reverse side. Each of the plurality of LED lighting units are attached to the reverse side of the first scrim fabric. Each scrim LED unit comprises a plurality of electrical cables for supplying electrical power to the LED lighting units and a main connector. Each electrical cable is capable of having multiple LED lighting units spaced thereupon. The main connector interconnects the interface unit to each of the plurality of electrical cables. Each LED lighting unit comprises an LED light and a mounting frame. Each LED light is detachably coupled to the mounting frame. Each mounting frame affixes the LED lights onto the reverse side of the first scrim fabric.

In another embodiment, the present invention provides a lighting system comprising a plurality of lighting apparatuses. Each lighting apparatus comprises at least one scrim LED unit, an interface unit and at least one portable remote control unit. Each portable remote control unit is configured to exchange information with the interface unit. Each scrim LED unit comprises a first scrim fabric and a plurality of LED lighting units. The scrim fabric comprises a display side and a reverse side. Each of the plurality of LED lighting units are attached to the reverse side of the first scrim fabric. Each scrim LED unit comprises a plurality of electrical cables for supplying electrical power to the LED lighting units and a main connector. Each electrical cable is capable of having multiple LED lighting units spaced thereupon. The main connector interconnects the interface unit to each of the plurality of electrical cables. Each LED lighting unit comprises an LED light and a mounting frame. Each LED light is detachably coupled to the mounting frame. Each mounting frame affixes the LED lights onto the reverse side of the first scrim fabric.

These and other features, aspects and advantages of the present invention will become understood with reference to the following description, appended claims and accompanying figures.

### BRIEF DESCRIPTION OF THE DRAWINGS

FIG. 1 illustrates a scrim LED lighting apparatus, in accordance with an embodiment of the present invention.

FIG. 2A illustrates a row of LED lighting units, in accordance with an embodiment of the present invention.

FIG. 2B illustrates a scrim LED unit, in accordance with an embodiment of the invention.

FIG. 3A illustrates a side of an interface unit, in accordance with an embodiment of the invention.

FIG. 3B is a block diagram illustrating the internal components of an interface unit, in accordance with an embodiment of the invention.

FIG. 4 is a block diagram illustrating the internal components of a remote control unit configured for use with the scrim LED lighting apparatus, in accordance with an embodiment of the invention.

FIG. 5 is a block diagram illustrating a circuit comprising the scrim LED lighting apparatus, in accordance with an embodiment of the invention.

FIG. 6 is a block diagram illustrating multiple scrim LED lighting apparatuses arranged in a parallel lighting circuit, in accordance with an embodiment of the invention.

FIG. 7 is a block diagram illustrating multiple scrim LED lighting apparatuses arranged in a serial lighting circuit, in accordance with an embodiment of the present invention.

FIG. 8 is a block diagram illustrating multiple scrim LED units arranged in a parallel lighting circuit, in accordance with an embodiment of the present invention.

FIG. 9 is a block diagram illustrating multiple scrim LED units arranged in a serial lighting circuit, in accordance with an embodiment of the invention.

### DETAILED DESCRIPTION OF THE INVENTION

Embodiments of the present invention provide a lighting apparatus comprising at least one scrim LED unit, an interface unit, and at least one portable remote control. Each portable remote control unit is configured to exchange information with the interface unit.

Each scrim LED unit comprises a first scrim fabric and a plurality of LED lighting units. The first scrim fabric comprises a display side and a reverse side. Each of the plurality of LED lighting units are attached to the reverse side of the first scrim fabric.

Each scrim LED unit comprises a plurality of electrical cables for supplying electrical power to the LED lighting units and a main connector. Each electrical cable is capable of having multiple LED lighting units spaced thereupon. The main connector interconnects the interface unit to each of the plurality of electrical cables.

Each LED lighting unit comprises an LED light and a mounting frame. Each LED light is detachably coupled to the mounting frame. Each mounting frame affixes the LED lights onto the reverse side of the first scrim fabric.

Each scrim LED unit further comprises a second scrim fabric attached to the reverse side of the first scrim fabric. The second scrim fabric covers the plurality of LED lighting units and electrical cables coupled to the reverse side of the first scrim fabric.

The interface unit comprises a power supply component for supplying power to the scrim LED unit, a data input socket for receiving data control signals, and a data output socket for transmitting data control signals.

The interface unit further comprises a wireless transceiver configured to exchange information with at least one of the portable remote control units and an audio/visual interface configured to control operating functions of the lighting apparatus.

The lighting apparatus further comprises an external controller configured to control operating functions of the lighting apparatus by means of the interface unit.

In another embodiment, the present invention provides a lighting system comprising a plurality of lighting apparatuses. Each lighting apparatus comprises at least one scrim LED unit, an interface unit, and at least one portable remote control unit. Each portable remote control unit is configured to exchange information with the interface unit.

Each scrim LED unit comprises a first scrim fabric and a plurality of LED lighting units. The scrim fabric comprises a display side and a reverse side. Each of the plurality of LED lighting units are attached to the reverse side of the first scrim facbric.

Each scrim LED unit comprises a plurality of electrical cables for supplying electrical power to the LED lighting units and a main connector. Each electrical cable is capable of having multiple LED lighting units spaced thereupon. The main connector interconnects the interface unit to each of the plurality of electrical cables.

Each LED lighting unit comprises an LED light and a mounting frame. Each LED light is detachably coupled to the mounting frame. Each mounting frame affixes the LED lights onto the reverse side of the first scrim fabric.

Each scrim LED unit further comprises a second scrim fabric attached to the reverse side of the first scrim fabric. The second scrim fabric covers the plurality of LED lighting units and electrical cables coupled to the reverse side of the first scrim fabric.

The interface unit comprises a power supply component for supplying power to the scrim LED unit, a data input socket for receiving data control signals and a data output socket for transmitting data control signals.

The interface unit further comprises a wireless transceiver configured to exchange information with at least one of the portable remote control units and an audio/visual interface configured to control operating functions of the lighting apparatus.

In one embodiment, the plurality of lighting apparatuses is arranged in a parallel lighting circuit. The parallel lighting circuit is controlled by an external controller.

In another embodiment, the plurality of lighting apparatuses is arranged in a serial circuit. The serial circuit is controlled by an external controller.

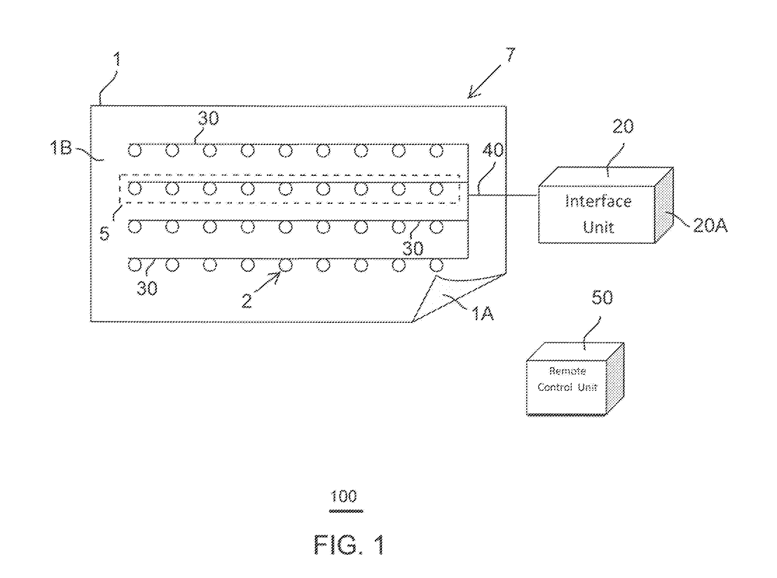

FIG. 1 illustrates a scrim LED lighting apparatus 100, in accordance with an embodiment of the present invention. The lighting apparatus 100 comprises a scrim LED unit 7, an interface unit 20, and one or more portable remote control units 50. The scrim LED unit 7 comprises a first scrim fabric 1 and a plurality of LED lighting units 2.

In one embodiment, the first scrim fabric 1 is made of fire-retardant transparent/translucent fabric. In another embodiment, the first scrim fabric 1 is made of white fabric. In another embodiment, the first scrim fabric 1 is made of a lightweight woven textile. In yet another embodiment, the first scrim fabric 1 is made of cotton or linen fabric comprising an open weave design. Regardless of its makeup, the first scrim fabric 1 has a display side 1A and a reverse side 1B, where in one embodiment the LED lighting units 2 are attached to the reverse side 1B.

The LED lighting units 2 are arranged in rows 5 of LED lighting units 2. The scrim LED unit 7 further comprises a plurality of electrical cables 30. Each row 5 includes multiple LED lighting units 2 spaced apart along an electrical cable 30 that supplies electrical power to the LED lighting units 2. In one embodiment, the rows 5 of LED lighting units 2 are arranged in a parallel orientation. In another embodiment, the LED lighting units 2 are arranged in multiple columns of LED lighting units 2.

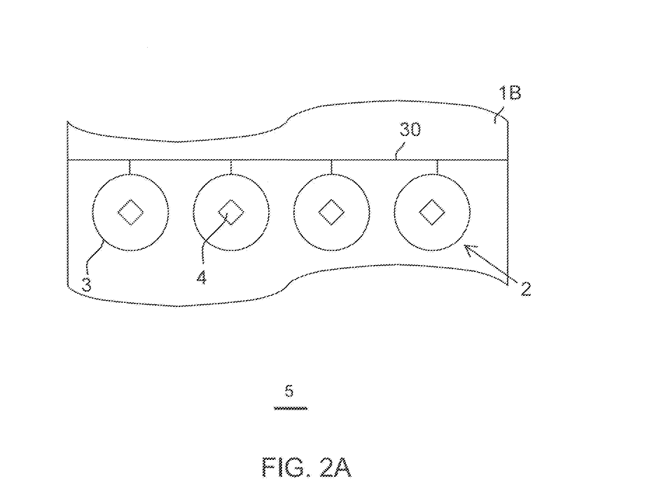

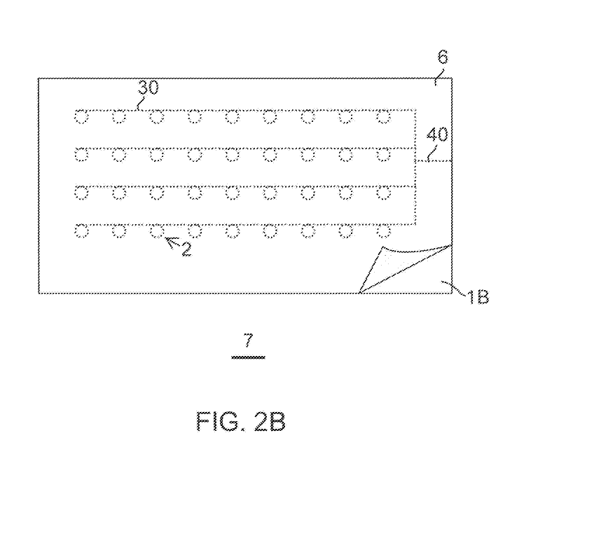

FIG. 2A illustrates a row 5 of LED lighting units 2, in accordance with an embodiment of the present invention. Each LED lighting unit 2 comprises an LED light 4 and mounting frame 3. The LED light 4 of each LED lighting unit 2 is detachably coupled to the mounting frame 3 of said LED lighting unit 2, thus allowing for the LED light 4 to be replaced if/when the LED light 4 is broken.

The mounting frame 3 is used to securely affix the LED light 4 to the reverse side 1B of the first scrim fabric 1 (FIG. 1). Light from each LED light 4 can radiate through (i.e., penetrate) the transparent/translucent first scrim fabric 1. The LED light 4 may comprise, for example, a semiconductor LED or an organic LED (OLED). Other types of light emitting elements, such as light bulbs, lasers or liquid crystal display (LCD) panels, may be used.

In one embodiment, each LED lighting unit 2 may be attached to the reverse side 1B of the first scrim fabric 1 (FIG. 1) by sewing the mounting frame 3 of said LED lighting unit 2 onto the reverse side 1B. Other attachment mechanisms may be used, such as tying, using fire-retardant adhesives or fasteners (e.g., screws, snaps, studs, etc.). Each of these attachment mechanisms may be used alone or in combination with other attachment mechanisms. Further, for each row 5 of LED lighting units 2, the cable 30 for said row 5 may also be secured to the reverse side 1B of the first scrim fabric 1 using similar attachment mechanisms.

For each row 5 of LED lighting units 2, each LED light 4 of said row 5 is coupled to the cable 30 of said row 5. The scrim LED unit 7 (FIG. 1) further comprises a main connector 40 (FIG. 1). The cable 30 of a row 5 interconnects every LED light 4 of said row 5 to the main connector 40. The main connector 40 interconnects the interface unit 20 (FIG. 1) to the cable 30 of each row 5 of LED lighting units 2.

FIG. 2B illustrates a scrim LED unit 7, in accordance with an embodiment of the invention. In one embodiment, the scrim LED unit 7 may comprise a second scrim fabric 6. The second scrim fabric 6 is similar to the aforementioned first scrim fabric 1 (FIG. 1), and may be attached to the reverse side 1B of the first scrim fabric 1 to cover the LED lighting units 2 and cables 30 attached on the reverse side 1B of the first scrim fabric 1.

In one embodiment, the interface unit 20 (FIG. 1) is external to the first scrim fabric 1 (FIG. 1), where in another embodiment the interface unit 20 is attached to the first scrim fabric 1.

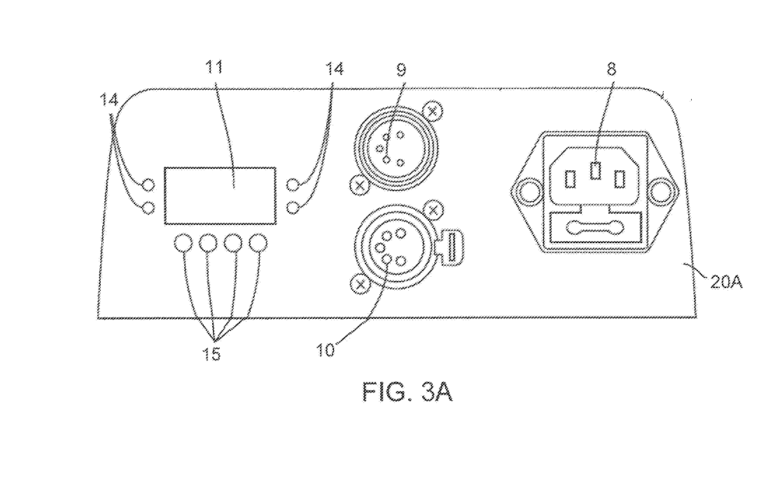

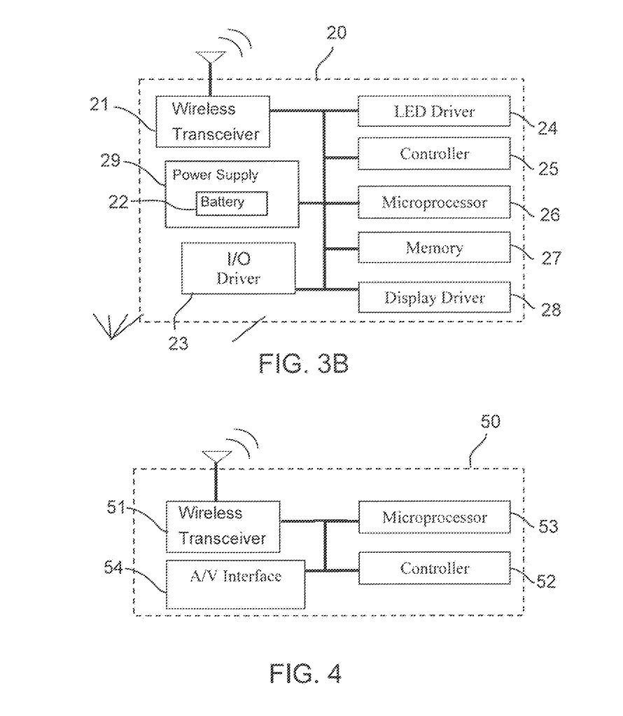

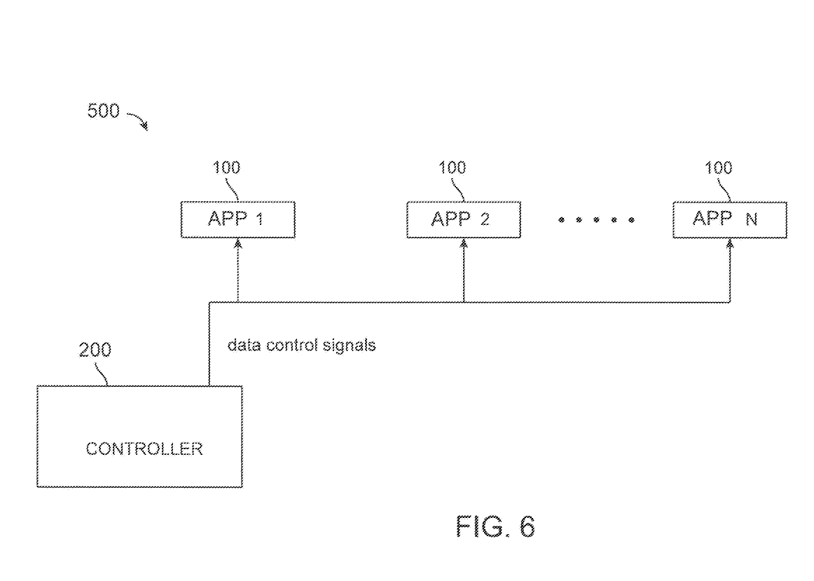

FIG. 3A illustrates a side 20A of an interface unit 20 (FIG. 1), in accordance with an embodiment of the invention. The side 20A (FIG. 1) of the interface unit 20 may include multiple electrical couplers/sockets to interface with data and power inputs/outputs. In one embodiment, the side 20A includes the power socket 8 for receiving power from a power supply source, a data input socket 9 for receiving data control signals such as Digital Multiplex (DMX) signals and a data output socket 10 for transmitting data control signals, such as DMX signals. DMX is a communications protocol allowing different devices to be linked together and to operate from a single controller 200 (FIG. 6), provided that the devices and the controller are DMX compliant.

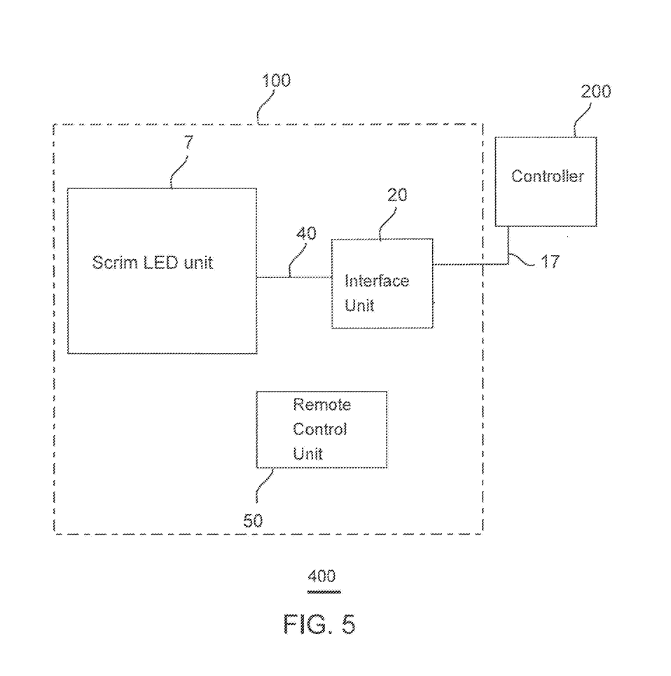

Operating functions of the lighting apparatus 100 may be controlled by an external controller 200 (FIG. 5), such as a DMX512 controller. Data control signals from the controller 200 are received by the interface unit 20 via the data input socket 9. The operating functions of the lighting apparatus 100 include setting and displaying a DMX address for the lighting apparatus 100 and controlling the lighting effects of the LED lights 4 (FIG. 2A), such as selectively lighting LED lights 4 or selectively adjusting the color temperature and/or brightness of LED lights 4.

Operating functions of the lighting apparatus 100 may also be controlled by a user utilizing an audio/visual interface on side 20A of the interface unit 20. For example, in one embodiment, side 20A further comprises an LCD display screen 11, multiple LED indicator lights 14, and multiple manual control buttons 15, which are used to display and control different operating functions of the lighting apparatus 100.

In one embodiment, the data input socket 9 is a DMX input socket 9 (e.g., a 3-pin DMX input connector or a 5-pin DMX input connector) and the data output socket 10 is a DMX output socket 10 (e.g., a 3-pin DMX output connector or a 5-pin DMX output connector). DMX signals received via the DMX input socket 9 comprise DMX data instructions from a DMX-compliant controller 200 (FIG. 6), such as a DMX512 controller. The lighting apparatus 100 may have a DMX address (e.g., a DMX512 address) used to route DMX signals thereto from the controller 200. The DMX signals received can control different operating functions of the lighting apparatus 100. The DMX output socket 10 can transmit DMX signals to another DMX-compliant device such as another lighting apparatus 100.

FIG. 3B is a block diagram illustrating the internal components of an interface unit 20, in accordance with an embodiment of the invention. As shown, the interface unit 20 further comprises circuits/logics for controlling different operating functions of the lighting apparatus 100. For example, in one embodiment, the interface unit 20 further comprises a wireless transceiver 21, a controller 25, a microprocessor 26, and a memory unit 27. The interface unit 20 further comprises a plurality of drivers, such as an LED driver 24, a display driver 28, and an input/output (I/O) driver 23.

The interface unit 20 comprises a power supply component 29, which supplies power to operate the scrim LED unit 7. In one embodiment, the power supply component 29 includes a battery 22 that provides electrical energy to power on and operate the scrim LED unit 7. In another embodiment, the power supply component 29 includes a power socket/coupler 8 (FIG. 3A) for receiving power from a power supply source, such as an A/C electrical socket.

The LED driver 24 controls the lighting effects of the LED lights 4 (FIG. 2A). For example, the LED driver 24 can selectively turn on or turn off each LED light 4. The LED driver 24 can also selectively adjust the color temperature and/or brightness of each LED light 4.

The display driver 28 controls the LCD display screen 11, the LED indicator lights 14, and the manual control buttons 15 (see FIG. 3A). The I/O driver 23 controls the power socket 8, the data input socket 9, and the data output socket 10 (see FIG. 3A). In one embodiment, the I/O driver is a DMX I/O driver.

The memory unit 27 maintains information such as a DMX address of the lighting apparatus 100. The microprocessor 26 is configured to process the data control signals received and the controller 25 is configured to forward control signals received to the LED driver 24, the display driver 28, and the I/O driver 23.

The transceiver 21 in FIG. 3B is configured to wirelessly exchange information (e.g., data control signals) with one or more portable remote control units 50 (FIG. 1). In one embodiment, the transceiver 21 operates on one or more radio frequencies. The transceiver 21 wirelessly receives radio frequency (RF) signals from, and wirelessly transmits RF signals to, a wireless transceiver 51 (FIG. 4) of a portable remote control unit 50. The RF signals received include data control signals. In another embodiment, the transceiver 21 wirelessly exchanges information (e.g., data control signals) with one or more portable remote control units 50 using infrared (IR) waves.

FIG. 4 is a block diagram illustrating the internal components of a remote control unit 50 configured for use with the scrim LED lighting apparatus 100, in accordance with an embodiment of the invention. The operating functions of the lighting apparatus 100 may also be controlled by a one or more portable remote control units 50. As shown in FIG. 4, each portable remote control unit 50 comprises the wireless transceiver 51, a microprocessor 53, a controller 52, and an A/V interface 54.

An operator of the lighting apparatus 100 can utilize the A/V interface 54 to remotely control the operating functions of the lighting apparatus 100. Specifically, the A/V interface 54 of the remote control unit 50 may comprise a graphic display, and alphanumeric and directional keypads that an operator can use to enter input commands. The A/V interface 54 may comprise other types of electronic and/or manual data input means.

The microprocessor 53 of the remote control unit 50 is configured to process the input commands entered by an operator via the A/V interface 54 and generate appropriate data control signals. The controller 52 of the remote control unit 50 is configured to generate RF signals including the data controls signals generated.

The transceiver 51 of the remote control unit 50 in FIG. 4 is configured to wirelessly exchange information (e.g., data control signals) with the interface unit 20 (FIG. 1). In one embodiment, the transceiver 51 operates on one or more radio frequencies. The transceiver 51 wirelessly receives RF signals from, and wirelessly transmits RF signals to, the wireless transceiver 21 (FIG. 3B) of the interface unit 20. In another embodiment, the transceiver 51 wirelessly exchanges information (e.g., data control signals) with the interface unit 20 using infrared (IR) waves.

FIG. 5 is a block diagram illustrating a circuit 400 comprising the scrim LED lighting apparatus 100, in accordance with an embodiment of the invention. The circuit 400 further comprises an external controller 200. The controller 200 provides data control signals for controlling different operating functions of the lighting apparatus 100. The interface unit 20 receives data control signals from the controller 200 via an electrical cord/cable 17 that is coupled to the data input socket 9 (FIG. 3A) of the interface unit 20.

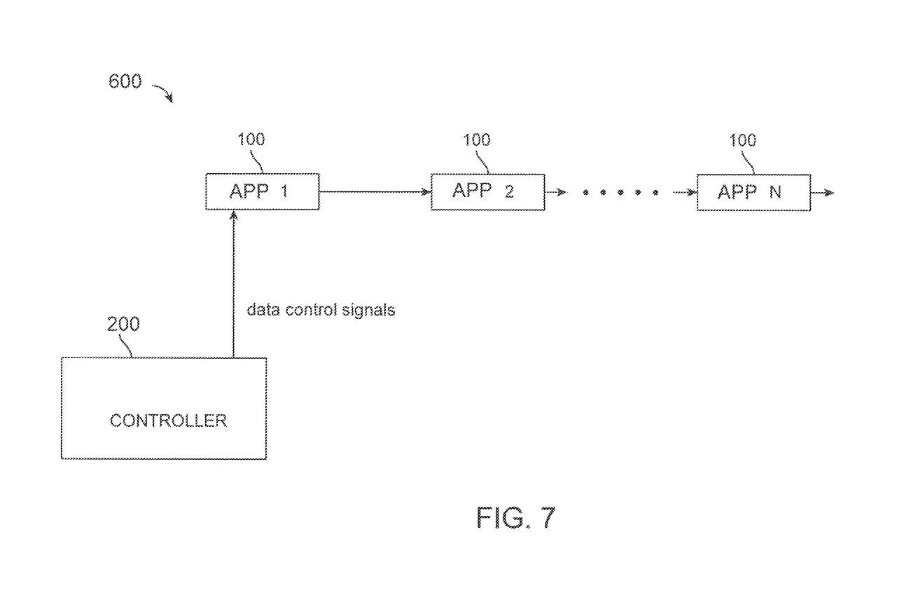

As described above, an operator may also utilize a portable remote unit 50 to remotely control the different operating functions of the lighting apparatus 100. The lighting apparatus 100 can be used as a standalone, in multiples, such as in a parallel lighting circuit 500 (FIG. 6), or linked in a master/slave configuration, such as a serial (i.e., daisy-chain) lighting circuit 600 (FIG. 7).

FIG. 6 is a block diagram illustrating multiple scrim LED lighting apparatuses 100 arranged in a parallel lighting circuit 500, in accordance with an embodiment of the invention. The circuit 500 is controlled by a controller 200, such as a DMX-compliant controller. Each lighting apparatus 100 receives data control signals (e.g., DMX signals) from the controller 200 via the data input socket 9 (FIG. 3A).

FIG. 7 is a block diagram illustrating multiple scrim LED lighting apparatuses 100 arranged in a serial (e.g., daisy-chain) lighting circuit 600, in accordance with an embodiment of the present invention. The circuit 600 is controlled by a controller 200, such as a DMX-compliant controller. In a daisy-chain circuit 600, data control signals (e.g., DMX signals) are sent as serial data that travel from one lighting apparatus 100 to another lighting apparatus 100 via the data I/O sockets 9, 10 (FIG. 3A) of each lighting apparatus 100. Specifically, the data input socket 9 receives master/slave data control signals and the data output socket 10 transmits master/slave data control signals to the next lighting apparatus 100 in the master/slave circuit 600. For example, as shown in FIG. 7, a first lighting apparatus 100 (APP 1) receives data control signals from the controller 200. The first lighting apparatus 100 then transmits data control signals to a second lighting apparatus 100 (APP 2).

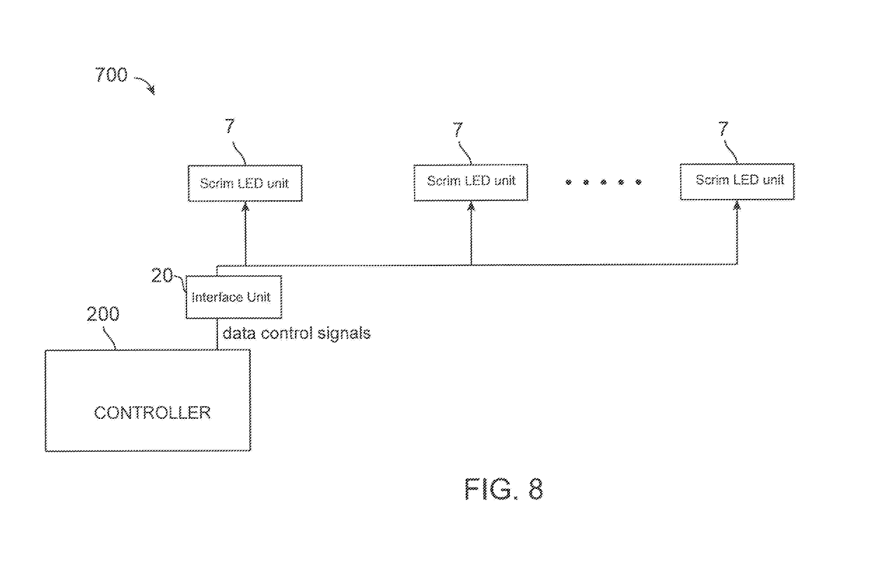

FIG. 8 is a block diagram illustrating multiple scrim LED units 7 arranged in a parallel lighting circuit 700, in accordance with an embodiment of the present invention. In one embodiment, multiple scrim LED units 7 are coupled to one interface unit 20. The circuit 700 is controlled by a controller 200, such as a DMX-compliant controller. Data control signals (e.g., DMX signals) from the controller 200 are received via the data input socket 9 (FIG. 3A) of the interface unit 20.

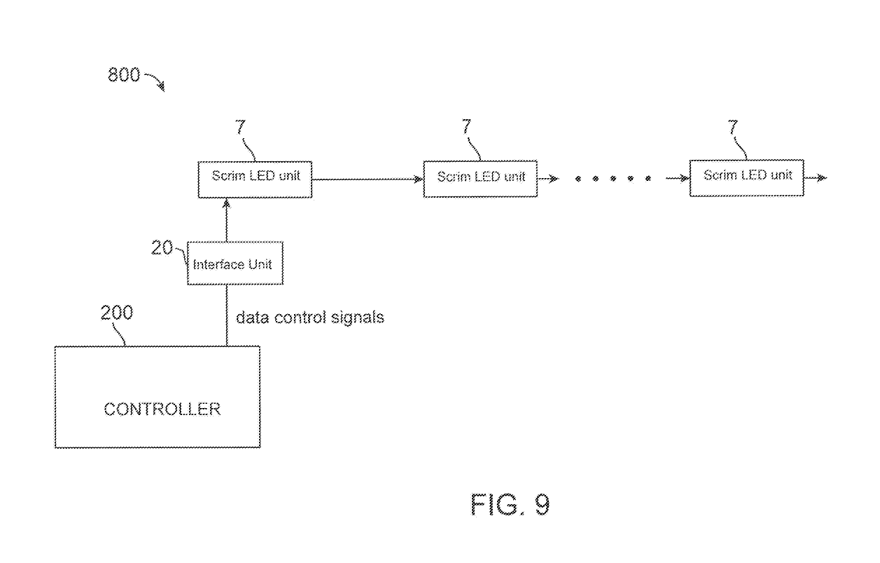

FIG. 9 is a block diagram illustrating multiple scrim LED units 7 arranged in a serial (e.g., daisy-chain) lighting circuit 800, in accordance with an embodiment of the invention. The circuit 800 is controlled by a controller 200, such as a DMX-compliant controller. Data control signals (e.g., DMX signals) from the controller 200 are received via the data input socket 9 (FIG. 3A) of the interface unit 20.

The scrim LED lighting apparatus 100 can be used to cover speaker stands, lighting stands, tables, and other structures or pieces of furniture.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lighting apparatus, comprising:
at least one scrim LED unit;
an interface unit; and
at least one portable remote control unit;
wherein each portable remote control unit is configured to exchange information with the interface unit.

2. The lighting apparatus of claim 1, wherein:
each scrim LED unit comprises:
a first scrim fabric; and
a plurality of LED lighting units.

3. The lighting apparatus of claim 2, wherein:
the first scrim fabric comprises:
a display side; and
a reverse side;
wherein the plurality of LED lighting units are attached to the reverse side of the first scrim fabric.

4. The lighting apparatus of claim 3, wherein:
each scrim LED unit further comprises:
a plurality of electrical cables for supplying electrical power to the LED lighting units; and
a main connector;
wherein multiple LED lighting units are spaced along an electrical cable; and
wherein the main connector interconnects the interface unit to each of the plurality of electrical cables.

5. The lighting apparatus of claim 4, wherein:
each LED lighting unit comprises:
an LED light; and
a mounting frame;
wherein each LED light is detachably coupled to the mounting frame of the LED lighting unit.

6. The lighting apparatus of claim 5, wherein:
the mounting frame affixes the LED lights onto the reverse side of the first scrim fabric.

7. The lighting apparatus of claim 6, wherein:
each scrim LED unit further comprises:
a second scrim fabric attached to the reverse side of the first scrim fabric;
wherein the second scrim fabric covers the pluralities of LED lighting units and electrical cables coupled to the reverse side of the first scrim fabric.

8. The lighting apparatus of claim 1, wherein:
the interface unit comprises:
a power supply component for supplying power to the scrim LED unit;
a data input socket for receiving data control signals; and
a data output socket for transmitting data control signals.

9. The lighting apparatus of claim 8, wherein:
the interface unit further comprises:
a wireless transceiver configured to exchange information with at least one of the portable remote control units.

10. The lighting apparatus of claim 9, wherein:
the interface unit further comprises:
an audio/visual interface configured to control operating functions of the lighting apparatus.

11. The lighting apparatus of claim 9, wherein:
the lighting apparatus further comprises:
an external controller configured to control operating functions of the lighting apparatus by means of the interface unit.

12. A lighting system, comprising:
a plurality of lighting apparatuses;
each lighting apparatus comprising:
at least one scrim LED unit;
an interface unit; and
at least one portable remote control unit;
wherein each portable remote control unit is configured to exchange information with the interface unit.

13. The lighting system of claim 12, wherein:
each scrim LED unit comprises:
a first scrim fabric comprising:
a display side; and
a reverse side; and
a plurality of LED lighting units;
wherein the plurality of LED lighting units are attached to the reverse side of the first scrim fabric.

14. The lighting system of claim 13, wherein:
each scrim LED unit further comprises:
a plurality of electrical cables for supplying electrical power to the LED lighting units; and
a main connector;
wherein multiple LED lighting units are spaced along an electrical cable; and
wherein the main connector interconnects the interface unit to each of the plurality of electrical cables.

15. The lighting system of claim 14, wherein:
each LED lighting unit comprises:
an LED light; and
a mounting frame;
wherein each LED light is detachably coupled to the mounting frame of the LED lighting unit; and
wherein the mounting frame affixes the LED lights onto the reverse side of the first scrim fabric.

16. The lighting system of claim 15, wherein:
each interface unit comprises:
a power supply component for supplying power to the scrim LED unit;
a data input socket for receiving data control signals;
a data output socket for transmitting data control signals; and
a wireless transceiver configured to exchange information with at least one of the portable control units.

17. The lighting system of claim 16, wherein:
each interface unit further comprises:
an audio/visual interface configured to control operating functions of the lighting apparatus.

18. The lighting system of claim 16, wherein:
the plurality of lighting apparatuses are arranged in a parallel lighting circuit;
wherein the parallel lighting circuit is controlled by an external controller.

19. The lighting system of claim 16, wherein:
the plurality of lighting apparatuses are linked together in a serial lighting circuit;
wherein the serial lighting circuit is controlled by an external controller.
